(19) United States
(12) Patent Application Publication
(10) Pub. No.: US 2009/0002614 A1
(43) Pub. Date: Jan. 1, 2009

(54) Liquid crystal display panel

(75) Inventors: Shui-Chih Lien, Hsin-Chu (TW); Yu-Chieh Cho, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/071,431

(22) Filed: Feb. 21, 2008

(30) Foreign Application Priority Data
Jun. 29, 2007 (TW) 96123843

(51) Int. Cl. G02F 1/1337; G02F 1/1343

(52) U.S. Cl. 349/123; 349/143

(57) ABSTRACT

A liquid crystal display (LCD) panel includes a first substrate, a first electrode, a second substrate, and a liquid crystal layer. The first electrode is disposed on the first substrate. The first electrode has a main slit, a first sub-slit and a first pinhole. The first sub-slit is connected to the main slit and the first pinhole is separated from the main slit. The second substrate is disposed over the first substrate. The liquid crystal layer is disposed between the first substrate and the second substrate.

This application claims the benefit of Taiwan Application No. 96123843, filed Jun. 29, 2007, the contents of which are herein incorporated by reference in its entirety.

### BACKGROUND OF THE INVENTION

1. Field of the Invention

The present invention relates to a liquid crystal display panel, and more particularly, to a liquid crystal display panel with several voltage-transmittance curves adapted to compensate therefor.

2. Description of the Related Art

Multi-domain vertical alignment (MVA) liquid crystal display (LCD) panel has been widely used in recently years since it achieves fast pixel response, wide viewing angles, high light transmittance, and high contrast at the cost of brightness and color reproduction.

In the structure of a conventional MVA-LCD panel, each pixel electrode of a thin film transistor (TFT) substrate has perpendicularly connected slits, and each common electrode of a color filter substrate includes protrusions corresponding to the slits in each pixel electrode.

However, the conventional MVA-LCD panel only has one voltage-transmittance curve, a user might find the serious phenomenon of color wash out or color shift when he looks squarely or sideways at the screen of the LCD panel. Therefore, the LCD panel has serious problems with its display performance, reducing the practicability of the LCD panel.

### SUMMARY OF THE INVENTION

The present invention provides an LCD panel with multiple voltage-transmittance curves for compensation. The LCD panel with multiple voltage-transmittance curves is utilized by various combination designs of a main slit, sub-slits, and pinholes in the electrodes to lessen the color wash out or color shift phenomenon generated from the LCD screen at the large viewing angle. Therefore, the display performance of the LCD panel can be greatly improved and the practicability of the LCD can be enhanced.

According to a first aspect of the present invention, a liquid crystal display (LCD) panel is provided. The LCD panel comprises: a first substrate, a first electrode, a second substrate, and a liquid crystal layer. The first electrode is disposed on the first substrate. The first electrode has a main slit, a first sub-slit, and a first pinhole. The first sub-slit is connected to the main slit, and the first pinhole is separated from the main slit. The second substrate is disposed over the first substrate. The liquid crystal layer is disposed between the first substrate and the second substrate.

According to a second aspect of the present invention, a liquid crystal display (LCD) panel is provided. The LCD panel comprises: a first substrate, a first electrode, a second substrate, and a liquid crystal layer. The first electrode is disposed on the first substrate. The first electrode has a main slit, a plurality of first pinholes, and a plurality of second pinholes. The first pinholes and the second pinholes are separated from the main slit. A distribution area of the first pinholes is substantially different from a distribution area of the second pinholes, and a number of the first pinholes are substantially different from a number of the second pinholes. The second substrate is disposed over the first substrate. The liquid crystal layer is disposed between the first substrate and the second substrate.

According to a third aspect of the present invention, a liquid crystal display (LCD) panel is provided. The LCD panel comprises: a first substrate, a first electrode, a second substrate, and a liquid crystal layer. The first electrode is disposed on the first substrate. The first electrode has a main slit, a first sub-slit, and a second sub-slit. The first sub-slit and the second sub-slit are substantially parallel with or non-perpendicular arranged with the main slit. A length of the first sub-slit is substantially different from a length of the second sub-slit. The second substrate is disposed over the first substrate. The liquid crystal layer is disposed between the first substrate and the second substrate.

### BRIEF DESCRIPTION OF THE DRAWINGS

The present invention will become more fully understood from the detailed description given herein below and the accompanying drawings, given by way of illustration only and thus not intended to be limitative of the present invention

FIG. 1A shows a top view of an LCD panel according to a first embodiment of the present invention.

FIG. 1B is a cross-sectional view of the LCD panel taken along a line 1B-1B′ of FIG. 1A.

FIG. 2 shows a top view of an LCD panel according to a second embodiment of the present invention.

FIG. 3 shows a top view of an LCD panel according to a third embodiment of the present invention.

FIG. 4 shows a top view of an LCD panel according to a fourth embodiment of the present invention.

FIG. 5 shows a top view of an LCD panel according to a fifth embodiment of the present invention.

FIG. 6 shows a side view of an LCD panel according to a sixth embodiment of the present invention.

FIG. 7 is an alternative design of the LCD panel in FIG. 6.

FIG. 8 shows a schematic view of a photoelectric device according to an embodiment of the present invention.

### DETAILED DESCRIPTION OF THE INVENTION

A liquid crystal display (LCD) panel may be executed to include a main slit, sub-slits, and pinholes combined with various combination designs in electrodes according to several embodiments of the present invention. A first electrode disposed on a first substrate of the LCD panel may have a design of at least one main slit and further combined with at least one sub-slit, at least one pinhole, or both of at least one sub-slit and at least one pinhole. A second electrode disposed on a second substrate of the LCD panel and the second electrode may have a design of at least one sub-slit, at least one pinhole, or both of at least one sub-slit and at least one pinhole. The various combination designs of two different sub-slits and two different pinholes in the first and second electrodes according to 112 examples of the present invention are illustrated in appendix 1 to appendix 3. However, the present invention is not limited thereto but covers arrangements with various combination designs of more than two different sub-slits and more than two different pinholes in the first and second electrodes. The executed exemplification of the present invention is described by way of the following embodiments.

### First Embodiment

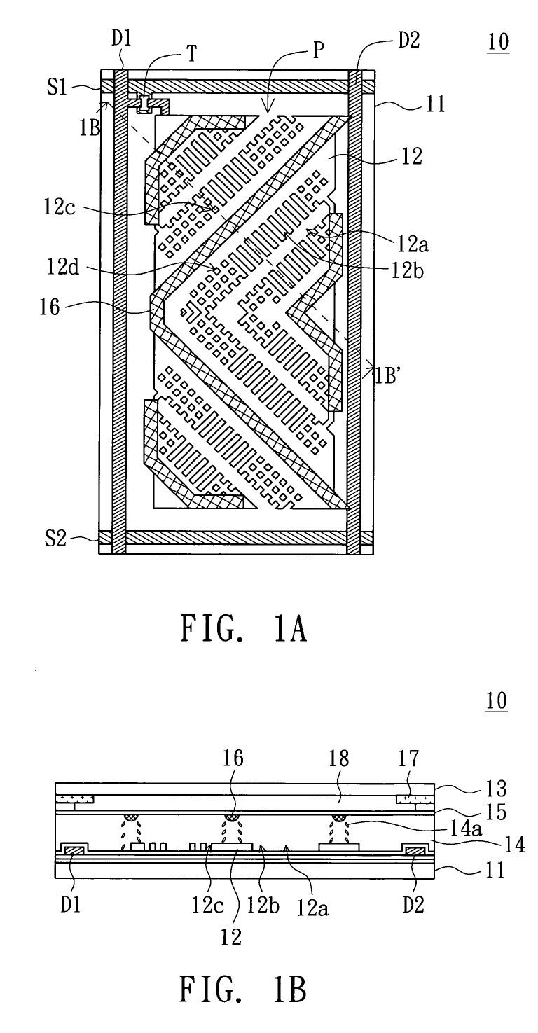

Referring to FIGS. 1A and 1B, a top view of an LCD panel according to a first embodiment of the present invention is shown in FIG. 1A while a cross-sectional view of the LCD panel taken along a line 1B-1B′ of FIG. 1A is shown in FIG. 1B. The LCD panel 10 includes a first substrate 11, a first electrode 12, a second substrate 13, and a liquid crystal layer 14. The first electrode 12 is disposed on the first substrate 11. The first electrode 12 has at least one main slit 12a, at least one first sub-slit 12b, and at least one first pinhole 12c. The first sub-slit 12b is connected to the main slit 12a, and the first pinhole 12c is separated from the main slit 12a (or namely the first pinhole 12C and the main slit 12a are isolated from or disconnected from each other). The second substrate 13 is disposed over the first substrate 11, such as the second substrate 13 is substantially parallel disposed with the first substrate 11. The liquid crystal layer 14, is disposed between the first substrate 11 and the second substrate 13, and includes a plurality of liquid crystal molecules 14a.

Besides, the first sub-slit 12b may be perpendicularly connected to the main slit 12a, and the shape of the main slit and the shape of the first sub-slit, for example, may be substantially stripe type. However, the shape of the first sub-slit, the shape of the main slit and the connection relationship are not limited thereto, and the shape of the first sub-slit, the shape of the main slit may be a substantially polygon, such as a substantially square, a substantially rectangle, a substantially circle, a substantially elliptical, a substantially triangle, a substantially pentagon, a substantially hexagon, a substantially rhombus, a substantially radiated shape, other shape and combinations thereof. The LCD panel 10 further includes a second electrode 15 and at least one alignment component 16. The second electrode 15 is disposed on the second substrate 13. The alignment component 16 may be a protrusion disposed on the second electrode 15 and corresponding to the main slit 12a. As shown in FIG. 1A, the protrusion 16 is substantially parallel with the main slit 12a. Preferably, the protrusion 16 and the main slit 12a are alternately arranged. In other words, the alignment component 16 and main slit 12a are projected on same planar, such as first substrate 11 or second substrate 13, and then may be found the protrusion 16 is substantially parallel with the main slit 12a from the top view or back view. The shape of the protrusion 16, for example, may are stripe type, but not limited thereto.

Further, the first electrode 12, preferably, has one or more second pinholes 12d. The first pinholes 12c and the second pinholes 12d are separated by the main slit 12a (or namely the first pinhole 12C and the second pinholes 12d are isolated from or disconnected from each other). The distribution area of the first pinholes 12c is substantially different from the distribution area of the second pinholes 12d. The number of the first pinholes 12c, preferably, is substantially different from the number of the second pinholes 12d, for example, the number of the first pinholes 12c is 12 while the number of the second pinholes 12d is 8, but not limited thereto. In other embodiment, the number if the first pinholes 12c is substantially equal to the number of the second pinholes 12d. The size of at least one of the first pinholes 12c is substantially equal to the size of one of the second pinholes 12d, preferably, the size of each of the first pinholes 12c is substantially equal to the size of each of the second pinholes 12d, but not limited thereto. In other embodiment, the size of at least one of the first pinholes 12c is substantially different from the size of one of the second pinholes 12d. At least one of the first pinhole 12c and the second pinhole 12d is a substantial square but may be selective other shape such as a substantial rectangle, a substantial circle, a substantial elliptical, a substantial triangle, a substantial pentagon, a substantial hexagon, a substantial rhombus, a substantial radiated shape, a substantial star shape, other shape, or combinations thereof.

The above-mentioned design of the main slit 12a and the protrusion 16 assists with the LC molecules 14a to form several domains so that the LCD panel 10 becomes a multi-domain vertical alignment (MVA) LCD panel. The design of the first pinhole 12c of the embodiment can effectively decreases the effective electric field between the first electrode 12 and the second electrode 15. Therefore, the design of the main slit 12a combined with the first sub-slit 12b and the first pinhole 12c according to the first embodiment can let the LCD panel 10 have multiple different voltage-transmittance (V-T) curves for compensation so as to decrease color wash out or color shift observed by the user when he looks squarely or sideways at the screen of the LCD panel 10.

One of the first substrate 11 and the second substrate 12 includes a pixel array, a color filter, and combinations thereof. In the present embodiment, the first substrate 11 is exemplified by including the pixel array while the second substrate 12 is exemplified by including the color filter, but not limited thereto. The pixel array includes several scan lines and several data lines. As shown in FIG. 1A, the pixel array includes a first scan line S1, a second scan line S2, a first data line D1 and a second data line D2. The first and second scan lines S1 and S2 and the first and second data lines D1 and D2 are disposed on the first substrate 11 and substantially interlace to define a pixel P is one of the pixel array. In other embodiment, the pixel P can be defined by other lines (not shown) such as the common lines substantially interlace to the data lines D1 and D2. The first scan line S1 is substantially parallel with the second scan line S2 while the first data line D1 is substantially parallel with the second data line D2. Furthermore, a switch component T, such as a thin film transistor (TFT), and a first electrode 12 are disposed in the pixel P. The thin film transistor T is electrically connected with the first scan line S1, the first data line D1, and the first electrode 12 and is as a switch component of the pixel P, and the first electrode 12 is as a pixel electrode. The main slit 12a is substantially tilted at an angle relative to the first scan line S1. The titled angle may be about 45 degrees, but not limited thereto. For example, if an absolute value of tilted angle is about 90 degrees, included angles between the main slit 12a and the first scan line S1 range from about 0 to about 90 degrees. If an absolute value of tilted angle is about 180 degrees, included angles between the main slit 12a and the first scan line S1 range from about 0 to about 180 degrees. If an absolute value of tilted angle is about 360 degrees, included angles between the main slit 12a and the first scan line S1 range from about 0 to about 360 degrees. Moreover, types of the thin film transistor T may be top-gate, bottom-gate, or other type. The material for forming the active layer of the thin film transistor T is selected from amorphous crystal material contains silicon (such as a-Si, or others), poly crystal material contains silicon (such as poly-Si, or others), microcrystalline material contains silicon (such as uC—Si, or others), single crystal material contains silicon (such as single crystal Si, or others), other material, and combination thereof.

In general, each one pixel P of the pixel array further comprises at least one opening or hole (not shown) within different functions, for example, as a hole is located at a place that the first electrode 12 is connected with the switch component T (such as the drain of the TFT), and therefore namely the hole is as contacted hole or contacted opening within connected function with the first electrode 12 and the switch component T, wherein the hole is being in the insulator and the first electrode 12 is disposed into the hole. Or as one pixel P of the pixel array having a least one capacitor is a metal-insulator-ITO or conductive-insulator-pixel electrode (MII type), the opening is located at a place that the first electrode 12 (such as pixel electrode) is connected with the conductive layer (not shown), and therefore the opening within connected function with the pixel electrode and the conductive layer, wherein the hole is being in the insulator and the first electrode 12 is disposed into the hole. In addition, the embodiments of the present invention, the locations of the pinhole, the main slit, and the sub-slits are not exist the materials of the first electrode 12 can seen the cross-section of the FIG. 1B or likes, but the locations of the other opening or hole are must exist the materials of the first electrode 12 therein to form the connected function. It is note that the each one pixel P of the pixel array further comprises at least one opening or hole (not shown) within different functions is not as the pinhole of the present embodiment and the below embodiments because the locations, the distributions, the hole exist or not exist the material of the first electrodes 12, and the functions are fully different from each other.

Preferably, the LCD panel 10 further includes a black matrix 17 disposed on the second substrate 13. The black matrix 17, preferably, is substantially corresponding to the first scan line S1, the second scan line S2, the first data line D1, and the second data line D2 and may be further substantially corresponding to other devices (such as the thin film transistor T), is adapted to prevent a problem of a light leakage, but not limited thereto. The LCD panel 10 may be selectively not to have the black matrix, or a stacked areas of a color filter 18 may be regarded as the black matrix 17 instead. The color filter 18 is substantially corresponding to the pixel P and selectively covers or not covers the black matrix 17 on the second substrate 13 is adapted to provide color light such as red (R), green (G), blue (B), or other color (such as yellow, cyan, reddish orange, violet, and so on). The second electrode 15 disposed on the color filter 18 is as a common electrode.

Further, the second electrode 15 may have a design of at least one sub-slit, at least one pinhole, or at least one sub-slit and at least one pinhole. In the design of at least two sub-slits, these sub-slits have substantially different lengths, but not limited thereto; these sub-slits may have substantially identical lengths. In the design of at least two pinholes, these pinholes have substantially different distribution areas and/or numbers. Preferably, these pinholes have substantially different distribution areas and numbers, but not limited thereto; these pinholes may have substantially identical distribution areas and/or numbers. In the design of at least one sub-slit and at least one pinhole, the sub-slit is separated from the pinhole. Besides, longitudinal axes of the sub-slit of the second substrate and the main slit 12a of the first substrate 11 preferably are substantially parallel with each other, such as substantially identical directional, but not limited thereto. These longitudinal axes may be substantially non-parallel, such as substantially perpendicular to or substantially interlace to form an angle other than 90 degrees (or namely any angles).

Moreover, the protrusion 16 on the second electrode 15 may be replaced by a projected ball (not shown in figure), for example, is substantially corresponding to the central area of the first electrode 12 and is adapted to assist the liquid crystal molecules 14a to form several domains. The pinholes 12d and 12c are a substantially square, but at least one of the pinholes 12d and 12c may be any shape, such as a substantially rectangle, a substantially circle, a substantially elliptical, a substantially triangle, a substantially pentagon, a substantially hexagon, a substantially rhombus, a substantially radiated shape, other shape and combinations thereof. In addition, ends of the main slit 12a are tip-shaped as an exemplification, but not limited thereto, may be substantially curved, substantially bevel, substantially multilateral, or other type.

### Second Embodiment

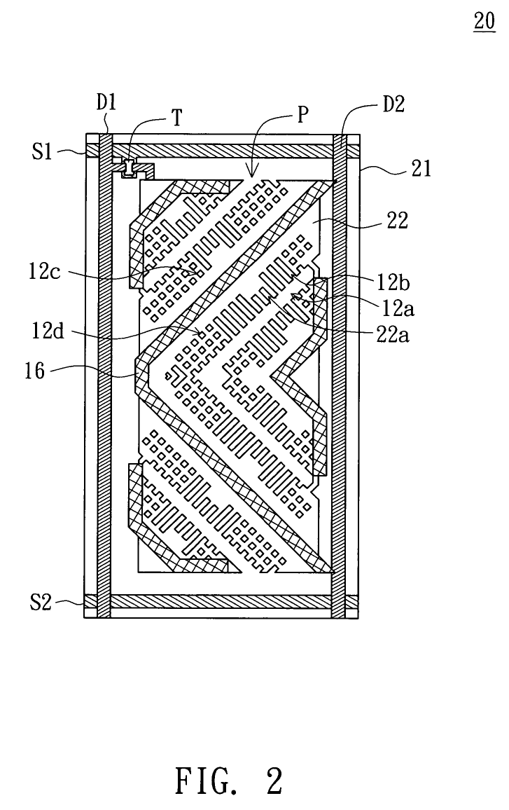

Referring to FIG. 2, a top view of an LCD panel according to a second embodiment of the present invention is shown. The difference between the LCD panel 20 of the present embodiment and the LCD panel 10 of the first embodiment is being in the first substrate. Specifically, the first electrode 22 on the first substrate 21 in the LCD panel 20 is different from that in the LCD panel 10. Other similar components are continued to use the reference numerals in the first embodiment without further description.

As compared the first electrode 12 of the first embodiment, the first electrode 22 as shown in FIG. 2 further has a second sub-slit 22a connected with the main slit 12a. The second sub-slit 22a is separated from the first sub-slit 12b (or namely the first sub-slit 12b and the second sub-slit 22a are isolated from or disconnected from each other). A length of the second sub-slit 22a, preferably, is substantially different from a length of the first sub-slit 12b, but not limited thereto, the length of the second sub-slit 22a may be substantially equal to the length of the first sub-slit 12b. For example, the length of the second sub-slit 22a is substantially less than the length of the first sub-slit 12b. The first sub-slit 12b and the second sub-slit 22a, preferably, are substantially parallel with each other, but can be substantially non-parallel, such as substantially perpendicular or substantially interlace to form an angle other than 90 degrees (or namely substantially interlace to form any angles). Besides, the second sub-slit 22a may be substantial perpendicularly connected to the main slit 12a, and the second sub-slit 22a is stripe-shaped as an exemplification. However, the shape of the second sub-slit 22a and the connection relationship are not limited thereto. The second sub-slit 22a can have any shape such as a substantially square, a substantially elliptical, a substantially circle, a substantially rhombus, or a substantially polygon. As compared with the first embodiment, the first electrode 22 according to the present embodiment has both of the first sub-slit 12b and the second sub-slit 22a and omits pinhole design, or has both of the first sub-slit 12b and the second sub-slit 22a and can further selectively have a pinhole or two pinholes.

Further, the second electrode on the second substrate, which is substantially parallel with the first electrode 22 on the first substrate 21 or namely disposed over the first electrode 22 on the first substrate 21, may have a design of at least one sub-slit, at least one pinhole, or at least one sub-slit and at least one pinhole. In the design of at least two sub-slits, preferably, these sub-slits have substantially different lengths, but not limited thereto; these sub-slits may has substantially identical lengths. In the design of at least two pinholes, preferably, these pinholes have substantially different distribution areas and/or numbers, but not limited thereto; these pinholes have substantially identical distribution areas and/or numbers. In the design of at least one sub-slit and at least one pinhole, the sub-slit is separated from the pinhole (or namely the sub-slit and the pinhole are isolated from or disconnected from each other). Besides, longitudinal axes of the sub-slit of the second substrate and the main slit 12a of the first substrate 21 preferably are substantially parallel with each other, such as substantially identical directional, but not limited thereto. These longitudinal axes may be substantially non-parallel, such as substantially perpendicular to or substantially interlace to form an angle other than 90 degrees (or namely any angles). In the present embodiment, the pinholes 12d and 12c are square, but at least one of the pinholes 12d and 12c can have other shape, such as a substantially rectangle, a substantially circle, a substantially elliptical, a substantially triangle, a substantially pentagon, a substantially hexagon, a substantially rhombus, a substantially radiated shape, a substantially star shape, other shape, or combinations thereof. In addition, ends of the main slit 12a are tip-shaped as an exemplification, but not limited thereto, can be substantially curved, substantially bevel, substantially multilateral, or other type.

### Third Embodiment

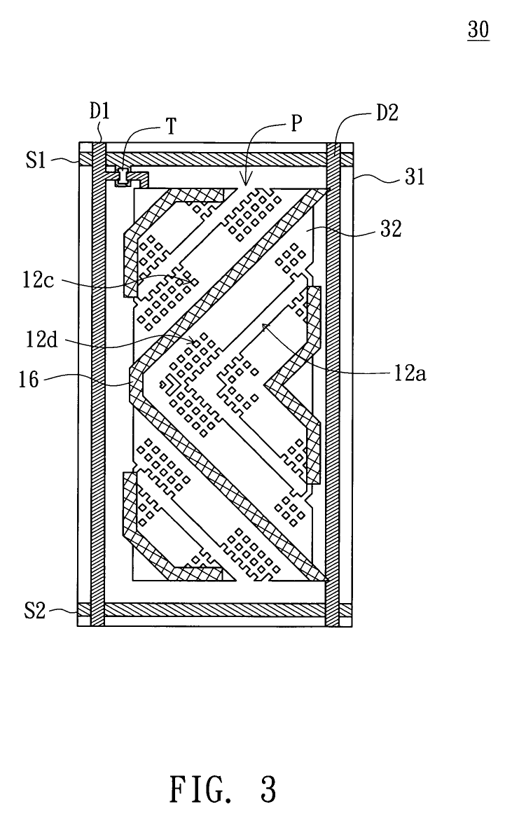

Referring to FIG. 3, a top view of an LCD panel according to a third embodiment of the present invention is shown. The difference between the LCD panel 30 of the present embodiment and the LCD panel 10 of the first embodiment is being in the first substrate. Specifically, the first electrode 32 on the first substrate 31 in the LCD panel 30 is different from that in the LCD panel 10. Other similar components are continued to use the reference numerals in the first embodiment without further description.

As compared the first electrode 12 of the first embodiment, the first electrode 32 as shown in FIG. 3 does not have the first sub-slit 12b in the first electrode 12. That is, the first electrode 32 only has the main slit 12a, the first pinhole 12c and the second pinhole 12d. As to the second electrode disposed opposite to the first electrode 32 may have a design of at least one sub-slit, at least one pinhole, or at least one sub-slit and at least one pinhole. In the design of at least two sub-slits, preferably, these sub-slits have substantially different lengths, but not limited thereto; these sub-slits can have substantially identical lengths. In the design of at least two pinholes, preferably, these pinholes have substantially different distribution areas and/or numbers, but not limited thereto; these pinholes have substantially identical distribution areas and/or numbers. In the design of at least one sub-slit and at least one pinhole, the sub-slit is separated from the pinhole. Besides, longitudinal axes of the sub-slit of the second substrate and the main slit 12a of the first substrate 31 preferably are substantially identical directional, such as substantially parallel with each other, but not limited thereto. These longitudinal axes may be substantially non-parallel, such as substantially perpendicular to or substantially interlace to form an angle other than 90 degrees (or namely any angles). In the present embodiment, the pinholes 12d and 12c are square, but at least one of the pinholes 12d and 12c can have other shape, such as a substantially rectangle, a substantially circle, a substantially elliptical, a substantially triangle, a substantially pentagon, a substantially hexagon, a substantially rhombus, a substantially radiated shape, a substantially star shape, other shape, or combinations thereof. In addition, ends of the main slit 12a are tip-shaped as an exemplification, but not limited thereto, can be substantially curved, substantially bevel, substantially multilateral, or other type.

### Fourth Embodiment

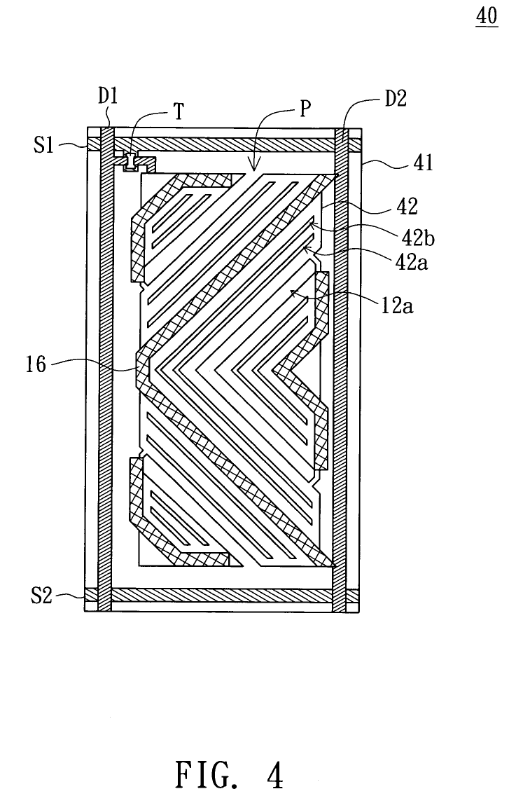

Referring to FIG. 4, a top view of an LCD panel according to a fourth embodiment of the present invention is shown. The difference between the LCD panel 40 of the present embodiment and the LCD panel 10 of the first embodiment is being in the first substrate. Specifically, the first electrode 42 on the first substrate 41 in the LCD panel 40 is different from that in the LCD panel 10. Other similar components are continued to use the reference numerals in the first embodiment without further description.

As shown in FIG. 4 the first electrode 42 has a main slit 12a, a first sub-slit 42a, and a second sub-slit 42b. Preferably, the first sub-slit 42a is substantially parallel with the main slit 12a while the second sub-slit 42b is substantially parallel with the main slit 12a as an exemplification. However, the first sub-slit 42a may be substantially parallel with or substantial non-perpendicularly arranged with (such as substantial non-perpendicularly connected, substantially non-parallel with, or others type) the main slit 12a while the second sub-slit 42b may be substantially parallel with or non-perpendicularly arranged with (such as non-perpendicularly connected or substantially non-parallel with, or others type) the main slit 12a. A length of the first sub-slit 42a, preferably, is substantially different from a length of the second sub-slit 42b, but not limited thereto; these sub-slits may have substantially identical lengths. In addition, ends of the main slit 12a, the first sub-slit 42a and the second sub-slit 42b are substantially bevel as an exemplification, but may be substantially curved, tip-shaped, substantially multilateral, or other type instead.

As to the second electrode on the second substrate on the first substrate 41, the second electrode can have a design of at least one sub-slit, at least one pinhole, or at least one sub-slit and at least one pinhole. In the design of at least two sub-slits, preferably, these sub-slits have substantially different lengths, but not limited thereto; these sub-slits can have substantially identical lengths. In the design of at least two pinholes, preferably, these pinholes have substantially different distribution areas and/or numbers, but not limited thereto; these pinholes may have substantially identical distribution areas and/or numbers. In the design of at least one sub-slit and at least one pinhole, the sub-slit is separated from the pinhole. Besides, longitudinal axes of the sub-slit of the second substrate and the main slit 12a of the first substrate 41 preferably have substantially parallel with each other, such as substantially identical directional, but not limited thereto. These longitudinal axes may be substantially non-parallel, such as substantially perpendicular or interlace to form an angle other than 90 degrees (or namely any angles).

### Fifth Embodiment

Referring to FIG. 5, a top view of an LCD panel according to a fifth embodiment of the present invention is shown. The difference between the LCD panel 50 of the present embodiment and the LCD panel 40 of the fourth embodiment is being in the first substrate. Specifically, the first electrode 52 on the first substrate 51 in the LCD panel 50 is different from that in the LCD panel 40. Other similar components are continued to use the reference numerals in the above-mentioned embodiments without further description.

As compared the first electrode 42 of the fourth embodiment, the first electrode 52 as shown in FIG. 5 further has one or more pinholes 52a separated from the main slit 12a, the first sub-slit 42a, and the second sub-slit 42b. In the present embodiment, the pinholes 52a are square but can have other shape, such as a substantially rectangle, a substantially circle, a substantially elliptical, a substantially triangle, a substantially pentagon, a substantially hexagon, a substantially rhombus, a substantially radiated shape, a substantially star shape, other shape, or combinations thereof. Preferably, the arrangement of the pinholes 52a are substantially parallel with at least one of the main slit 12a, the first sub-slit 42a, and the second sub-slit 42b, but not limited thereto; the arrangement of the pinholes 52a may be substantially non-parallel, for example, the arrangement of the pinholes 52a and one of the main slit 12a, the first sub-slit 42a and the second sub-slit 42b may be substantially perpendicular to or substantially interlace to form an angle other than 90 degrees (or namely any angles).

The second electrode disposed opposite to the first electrode 52 may have a design of at least one sub-slit, at least one pinhole, or at least one sub-slit and at least one pinhole. In the design of at least two sub-slits, preferably, these sub-slits have substantially different lengths, but not limited thereto; these sub-slits may have substantially identical lengths. In the design of at least two pinholes, preferably, these pinholes have substantially different distribution areas and/or numbers, but not limited thereto; these pinholes have substantially identical distribution areas and/or numbers. In the design of at least one sub-slit and at least one pinhole, the sub-slit is separated from the pinhole. Besides, longitudinal axes of the sub-slit of the second substrate and the main slit 12a of the first substrate 51 preferably are substantially identical directional, such as parallel with each other, but not limited thereto. These longitudinal axes may be substantially non-parallel, such as substantially perpendicular or interlace to form an angle other than 90 degrees (or namely any angles).

### Sixth Embodiment

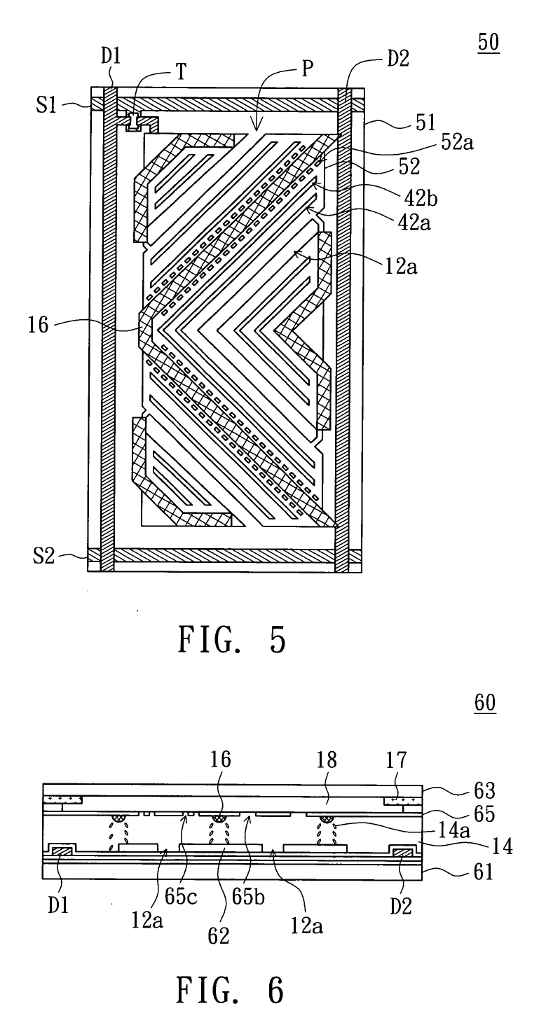

Referring to FIG. 6, a side view of an LCD panel according to a sixth embodiment of the present invention is shown. As compared with the LCD panels of the above-mentioned embodiments, the difference is being in the first electrode 62 of the first substrate 61 and the second electrode 65 of the second substrate 63. Other similar components are continued to use the reference numerals in the above-mentioned embodiment without further description.

As shown in FIG. 6, the first electrode 62 disposed on the first substrate 61 only has a main slit 12a while the various combination designs of the sub-slits 65b and the pinhole 65c are applied to the second electrode 65 of the second substrate 63 which is disposed opposite to the first electrode 61, such as second substrate 63 is parallel with the first substrate 61. The second electrode 65 may have a design of at least one sub-slit, at least one pinhole, or at least one sub-slit and at least one pinhole. In the design of at least two sub-slits, preferably, these sub-slits have substantially different lengths, but not limited thereto; these sub-slits may have substantially identical lengths. In the design of at least two pinholes, preferably, these pinholes have substantially different distribution areas and/or numbers, but not limited thereto, these pinholes have substantially identical distribution areas and/or numbers. In the design of at least one sub-slit and at least one pinhole, the sub-slit is separated from the pinhole. Besides, longitudinal axes of the sub-slit of the second substrate and the main slit 12a of the first substrate 61 preferably are substantially identical directional, such as parallel with each other, but not limited thereto. These longitudinal axes may be substantially non-parallel, such as substantially perpendicular or interlace to form an angle other than 90 degrees (or namely any angles).

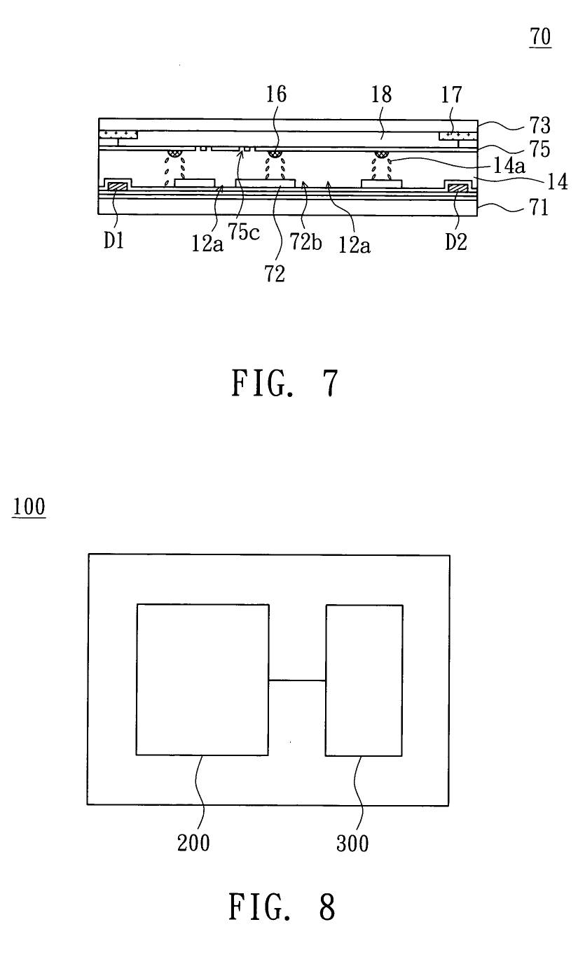

Referring to FIG. 7, a variation design of the LCD panel in FIG. 6 is shown. As compared with the LCD panels of the above-mentioned embodiments, the difference is being in the first electrode 72 of the first substrate 71 and the second electrode 75 of the second substrate 73. Other similar components are continued to use the reference numerals in the above-mentioned embodiment without further description.

As shown in FIG. 7, the first electrode 72 disposed on the first substrate 71 has a main slit 12a and a sub-slit 72b while the pinhole 75c is applied to the second electrode 75 of the second substrate 73, which is disposed opposite to the first substrate 71, such as the second substrate 73 is parallel with the first substrate 71. The first electrode 72 may have a design of at least one sub-slit, and the second electrode 75 may have a design of at least one pinhole. Besides, in the design of at least two sub-slits, preferably, these sub-slits have substantially different lengths, but not limited thereto, these sub-slits may have substantially identical lengths. In the design of at least two pinholes, preferably, these pinholes have substantially different distribution areas and/or numbers, but not limited thereto; these pinholes have substantially identical distribution areas and/or numbers. Besides, the longitudinal axes of the sub-slit 72a and the main slit 12a of the first substrates 71 preferably are substantially identical directional, such as parallel with each other, but not limited thereto. These longitudinal axes may be substantially non-parallel, such as substantially perpendicular to or substantially interlace to form an angle other than 90 degrees (or namely any angles).

Moreover, the liquid crystal layer with liquid crystal molecules according to the above-mentioned embodiments may be selectively mixed with light-emitting materials so that the liquid crystal layer may have a property of slight light-emitting, a property of transforming light colors (such as transforming white light into yellow light or other color light), or other properties. The light-emitting materials include light-emitting materials (fluorescence, phosphorescence, or the combination thereof, non-organic light-emitting materials (fluorescence, phosphorescence, or the combination thereof) or the combination thereof. Further, as shown in FIG. 8, the display panel 200 according to any one of the above-mentioned embodiments and an electronic component 300 connected with thereof, and forms an electro-optical device 100. The electronic component may be a controlling unit, an operating unit, a processing unit, an input unit, a memory unit, a driving unit, a light-emitting unit, a protecting unit, a sensing unit, other functional unit, or combinations thereof. The electro-optical device 100 may be a portable product (such as a mobile phone, a video camera, a camera, a notebook, a game machine, a watch, a music player, an e-mail transceiver, a GPS device, a digital photograph, or the like), an audio-video (AV) product (such as an AV displayer or the like), a screen, a television, an indoor/outdoor board, a display panel within a projector and so forth.

The LCD panel according to the above-mentioned embodiments of the present invention having various combination designs of a main slit, sub-slits, and pinholes in the electrodes has multiple voltage-transmittance curves for compensation so as to lessen color wash out or color shift observed by the user when he looks squarely or sideways at the screen of the LCD panel. Therefore, the display performance of the LCD panel can be greatly improved and the practicability of the LCD can be enhanced.

While the present invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) panel, comprising:
a first substrate;
a first electrode, disposed on the first substrate, wherein the first electrode has a main slit, a first sub-slit, and a first pinhole, the first sub-slit is connected to the main slit, and the first pinhole is separated from the main slit;
a second substrate disposed over the first substrate; and
a liquid crystal layer disposed between the first substrate and the second substrate.

2. The LCD panel according to claim 1, further comprising:
a second electrode disposed on the second substrate; and
an alignment component disposed on the second electrode and corresponding to the main slit.

3. The LCD panel according to claim 2, wherein the second electrode has a second sub-slit and a second pinhole, and the second sub-slit is separated from the second pinhole.

4. The LCD panel according to claim 2, wherein the second electrode has a second sub-slit and a third sub-slit, and the length of the second sub-slit is substantially different from the length of the third sub-slit.

5. The LCD panel according to claim 2, wherein the second electrode has a plurality of second pinholes and a plurality of third pinholes, a distribution area of the second pinholes is substantially different from a distribution area of the third pinholes, and a number of the second sub-slits are substantially different from a number of the third sub-slits.

6. The LCD panel according to claim 1, wherein the first electrode further has a second sub-slit, the second sub-slit is connected to the main slit and separated from the first sub-slit, and the length of the second sub-slit is substantially different from the length of the first sub-slit.

7. The LCD panel according to claim 1, wherein one of the first substrate and the second substrate includes a pixel array, a color filter, and combinations thereof.

8. A liquid crystal display (LCD) panel, comprising:
a first substrate;
a first electrode, disposed on the first substrate, wherein the first electrode has a main slit, a plurality of first pinholes, and a plurality of second pinholes, the first pinholes and the second pinholes are separated from the main slit, a distribution area of the first pinholes is substantially different from a distribution area of the second pinholes, and a number of the first pinholes are substantially different from a number of the second pinholes;
a second substrate disposed over the first substrate; and
a liquid crystal layer disposed between the first substrate and the second substrate.

9. The LCD panel according to claim 8, further comprising:
a second electrode disposed on the second substrate; and
an alignment component disposed on the second electrode and corresponding to the main slit.

10. The LCD panel according to claim 9, wherein the second electrode has a sub-slit and a third pinhole, and the sub-slit is separated from the third pinhole.

11. The LCD panel according to claim 9, wherein the second electrode has a first sub-slit and a second sub-slit, and the length of the first sub-slit is substantially different from the length of the second sub-slit.

12. The LCD panel according to claim 9, wherein the second electrode has a plurality of third pinholes and a plurality of fourth pinholes, a distribution area of the third pinholes is substantially different from a distribution area of the fourth pinholes, and a number of the third pinholes are substantially different from a number of the fourth pinholes.

13. The LCD panel according to claim 8, wherein the first electrode further has a sub-slit, the sub-slit is connected to the main slit and separated from the first pinholes and the second pinholes.

14. The LCD panel according to claim 8, wherein a size of at least one of the first pinholes is substantially equal to a size of one of the second pinholes.

15. The LCD panel according to claim 8, wherein one of the first substrate and the second substrate includes a pixel array, a color filter, and combinations thereof.

16. A liquid crystal display (LCD) panel, comprising:
a first substrate;
a first electrode, disposed on the first substrate, wherein the first electrode has a main slit, a first sub-slit, and a second sub-slit, the first sub-slit is substantially parallel with or non-perpendicularly arranged with the main slit, the second sub-slit is substantially parallel with or non-perpendicularly arranged with the main slit, and a length of the first sub-slit is different from a length of the second sub-slit;
a second substrate disposed over the first substrate; and
a liquid crystal layer disposed between the first substrate and the second substrate.

17. The LCD panel according to claim 16, further comprising:
a second electrode disposed on the second substrate; and
an alignment component disposed on the second electrode and corresponding to the main slit.

18. The LCD panel according to claim 17, wherein the second electrode has a third sub-slit and a pinhole, and the third sub-slit is separated from the pinhole.

19. The LCD panel according to claim 17, wherein the second electrode has a third sub-slit and a fourth sub-slit, and a length of the third sub-slit is substantially different from a length of the fourth sub-slit.

20. The LCD panel according to claim 17, wherein the second electrode has a plurality of first pinholes and a plurality of second pinholes, a distribution area of the first pinholes is substantially different from a distribution area of the second pinholes, and a number of the first pinholes are substantially different from a number of the second pinholes.

21. The LCD panel according to claim 16, wherein the first electrode further has a pinhole, the pinhole is separated from the main slit, the first sub-slit, and the second sub-slit.

22. The LCD panel according to claim 16, wherein one of the first substrate and the second substrate includes a pixel array, a color filter, and combinations thereof.
